(19) United States
(12) Patent Application Publication
(10) Pub. No.: US 2016/0285534 A1
(43) Pub. Date: Sep. 29, 2016

(54) Channel Estimation Techniques for FDD MIMO Systems

(71) Applicant: Alcatel-Lucent USA Inc., Murray Hill, NJ (US)

(72) Inventors: Li Erran Li, Edison, NJ (US); Michael G. Zierdt, Hillsborough, NJ (US)

(21) Appl. No.: 14/670,461

(22) Filed: Mar. 27, 2015

(51) Int. Cl. H04B 7/06; H04B 7/04; H04L 5/14

(52) U.S. Cl. CPC H04B 7/0626; H04L 5/14; H04B 7/0417

(57) ABSTRACT

In certain embodiments, a frequency-division duplexing (FDD) communication system has (i) a multiple in, multiple-out (MIMO) node with multiple MIMO-node antennas and (ii) a second node (e.g., a relay or a repeater) with at least one second-node antenna. The MIMO node transmits downlink (DL) signals to the second node over multiple DL channels in a DL frequency band (FB), and the second node transmits uplink (UL) signals to the MIMO node over multiple UL channels in a UL FB different from the DL FB. The MIMO node receives pilot signals from the second node in the UL and DL FBs and generates UL and DL FB channel state information (CSI) based on the received pilot signals. The MIMO node decodes UL data signals from the second node based on the UL FB CSI and generating DL data signals to the second node based on the DL FB CSI.

### BACKGROUND

1. Field of the Invention

The present invention relates to wireless communications and, more specifically but not exclusively, to channel estimation in frequency-division duplexing (FDD) cellular communication systems employing (i) macrocells having large-scale antenna system (LSAS also known as massive MIMO (multiple in, multiple out)) base stations and (ii) small cells having small-cell base stations like relays, repeaters, and full-fledged small-cell base stations.

2. Description of the Related Art

This section introduces aspects that may help facilitate a better understanding of the invention. Accordingly, the statements of this section are to be read in this light and are not to be understood as admissions about what is prior art or what is not prior art.

In conventional cellular communication systems having UE (user equipment) units (e.g., mobile devices) that communicate wirelessly with base stations (BSs) using frequency-division duplexing (FDD) involving different frequency bands for downlink and uplink transmissions, the channel state information (CSI) data for each downlink transmission channel and each uplink transmission channels between each BS antenna and each UE antenna needs to be individually estimated in order to successfully transmit data between the BSs and UEs.

To meet the ever-rising demands of wireless communications, cellular operators are deploying cellular communication systems that combine large-scale antenna system (LSAS) base stations and small-cell base stations, where each LSAS BS has tens or hundreds of antennas and is associated with a number of different small-cell BSs, and each small-cell BS communicates with a relatively small number of UEs. Operating with a large ratio for the number of LSAS BS antennas to the total number of small-cell BS antennas under simultaneous service can yield large increases in both spectral efficiency and energy efficiency. As the number of antennas increases and power is commensurately reduced, conjugate beamforming on the forward link (i.e., downlink) and matched-filtering on the reverse link (i.e., uplink) asymptotically approach near-optimal performance.

In these systems, each small-cell BS functions as a wireless node communicating backhaul data wirelessly with its associated LSAS BS. In general, an FDD cellular communication system having an LSAS BS with M antennas and L small-cell BSs, each having K antennas, will have 2M×L×K backhaul channels to estimate. The processing load required to estimate the CSI data for that many backhaul channels using conventional channel estimation techniques can become prohibitively expensive.

### SUMMARY

According to certain embodiments of the disclosure, an FDD communication system comprises a multiple in, multiple out (MIMO) node, such as an LSAS base station, and a second node, such as a relay or a repeater. When communicating user data, the MIMO node transmits downlink signals to the second node using a specified downlink frequency band for the FDD communication system, and the second node transmits uplink signals to the MIMO node using a specified, different uplink frequency band. In order to estimate the CSI data for processing such downlink and uplink signals, the second node is capable of transmitting pilot signals in either the uplink frequency band or the downlink frequency band, and the MIMO node is capable of receiving those pilot signals in either the uplink frequency band or the downlink frequency band.

In certain implementations, the second node has a configurable transmit chain that can be selectively configured to transmit pilot signals in either the downlink frequency band or the uplink frequency band. In addition, the MIMO node has a configurable receive chain for each MIMO-node antenna that can be selectively configured to process received pilot signals in either the downlink frequency band or the uplink frequency band. In order to estimate CSI data for use by the MIMO node in transmitting downlink user-data signals to the second node, the second node is configured to transmit “uplink” pilot signals in the downlink frequency band, and the MIMO node is configured to receive those “uplink” pilot signals in the downlink frequency band. Similarly, in order to estimate CSI data for use by the MIMO node in processing uplink user-data signals received from the second node, the second node is configured to transmit uplink pilot signals in the uplink frequency band, and the MIMO node is configured to receive those uplink pilot signals in the uplink frequency band.

In one embodiment, a frequency-division duplexing (FDD) communication system has (i) a multiple in, multiple-out (MIMO) node with multiple MIMO-node antennas and (ii) a second node with at least one second-node antenna, wherein (1) the MIMO node transmits downlink (DL) data signals to the second node over multiple DL channels in a DL frequency band (FB) and (2) the second node transmits uplink (UL) data signals to the MIMO node over multiple UL channels in a UL FB different from the DL FB. The MIMO node receives a first pilot signal from the second node in the UL FB and generates UL FB channel state information (CSI) based on the received first pilot signal. The MIMO node receives a second pilot signal from the second node in the DL FB and generates DL FB CSI based on the received second pilot signal. The MIMO node decodes UL data signals from the second node based on the UL FB CSI and generates DL data signals to the second node based on the DL FB CSI.

### BRIEF DESCRIPTION OF THE DRAWINGS

Other embodiments of the invention will become more fully apparent from the following detailed description, the appended claims, and the accompanying drawings in which like reference numerals identify similar or identical elements.

FIG. 1 is a simplified block diagram of a portion of an FDD wireless communication system employing both macrocells and small cells according to one embodiment of the present disclosure;

FIGS. 2A and 2B are simplified block diagrams representing the analog signal-processing portions of the TX and RX chains, respectively, of one of the transceivers of the LSAS BS of FIG. 1;

FIGS. 3A and 3B are simplified block diagrams representing the analog signal-processing portions of the RX and TX chains, respectively, of a transceiver of the relay of FIG. 1;

FIGS. 4A and 4B are simplified block diagrams representing the analog signal-processing portions of the RX and TX chains, respectively, of a transceiver of the repeater of FIG. 1;

FIG. 5 is a block diagram representing the overall downlink channel ĥₘₖ₁ for downlink transmissions from LSAS antenna m to small-cell antenna k in downlink (DL) frequency band FB1;

FIG. 6 is a block diagram representing the overall uplink channel ĝₖₘ₁ for uplink transmissions from small-cell antenna k to LSAS antenna m in DL FB1;

FIG. 7 is a flow diagram of a method for estimating all M uplink channels ĝₖₘ₁, m=1, . . . , M, in DL FB1 from relay antenna k of the relay of FIG. 1 to the M antennas m of the LSAS BS for use in transmitting downlink data signals from the LSAS BS to the relay;

FIG. 8 is a flow diagram of a method for estimating all M uplink channels ĝₖₘ₂, m=1, . . . , M, in uplink (UL) frequency band FB2 for uplink transmissions from relay antenna k to LSAS BS 112;

FIG. 9 is a flow diagram of a method for estimating channel data for use in transmitting downlink data signals from the LSAS BS of FIG. 1 to the repeater; and

FIG. 10 is a flow diagram of another method for estimating all M downlink channels ĥₘₖ₁, m=1, . . . , M, in DL FB1 from the LSAS BS of FIG. 1 to the relay.

### DETAILED DESCRIPTION

Detailed illustrative embodiments of the present invention are disclosed herein. However, specific structural and functional details disclosed herein are merely representative for purposes of describing example embodiments of the present invention. The present invention may be embodied in many alternate forms and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the,” are intended to include the plural forms as well, unless the context clearly indicates otherwise. It further will be understood that the terms “comprises,” “comprising,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

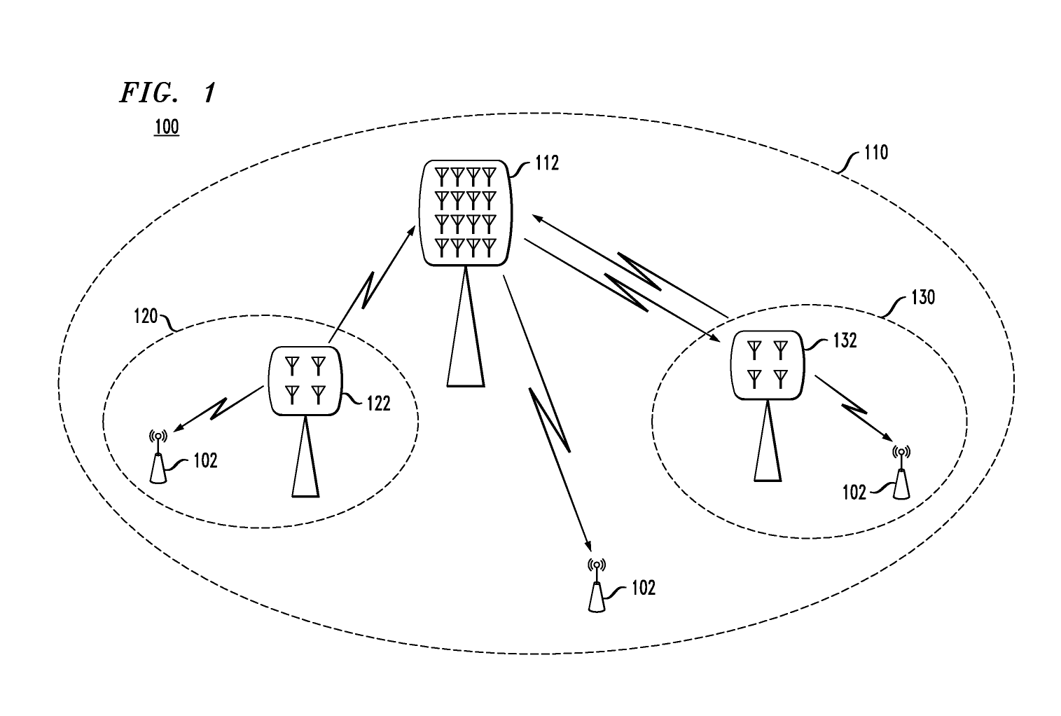

FIG. 1 is a simplified block diagram of a portion of an FDD wireless communication system 100 employing both macrocells and small cells according to one embodiment of the present disclosure. In particular, FIG. 1 shows a macrocell 110 comprising two small cells 120 and 130, where (i) LSAS base station 112 functions as the macrocell base station for macrocell 110, (ii) relay 122 functions as the small-cell base station for small cell 120, and (iii) repeater 132 functions as the small-cell base station for small cell 130. As indicated in FIG. 1, macrocell 110 also has a number of wireless users (e.g., mobile devices) 102, each of which wirelessly communicates directly with either LSAS BS 112, relay 122, or repeater 132. Relay 122 and repeater 132 also wirelessly communicate with LSAS BS 112.

In one possible implementation of system 100, all of the different nodes (i.e., LSAS BS 112, relay 122, repeater 132, and mobile devices 102) communicate using frequency-division duplexing. In another possible implementation of system 100, only the communications between (i) LSAS BS 112 and relay 122 and between (ii) LSAS BS 112 and repeater 132 use FDD with all other communications using time-division duplexing. The following discussion focuses on the FDD backhaul channels between (i) LSAS BS 112 and relay 122 and between (ii) LSAS BS 112 and repeater 132. Those skilled in the art will understand that analogous techniques can be employed for any suitable FDD communications.

Relay 122 and repeater 132 each can have one or more antennas, while LSAS BS 112 may have any suitably large number of BS antennas. As described further below, LSAS BS 112, relay 122, and repeater 132 each have transceiver circuitry comprising (i) transmit (TX) chains to generate outgoing signals to be transmitted by the one or more antennas and (ii) receive (RX) chains to process incoming signals received at the one or more antennas.

As used herein, the terms “macrocell” and “small cell” are used to indicate the relative sizes and relationships of the geographic regions covered by the base stations of those cells. In general, a macrocell contains one or more small cells, where each small-cell BS services a number of wireless users located within its small-cell region, and each macrocell BS services all of its small-cell BSs as well as all of the wireless users located within its macrocell region. Note that a macrocell BS can service some wireless users directly while servicing other wireless users via its small-cell BSs.

A macrocell BS can control its repeaters to function as MIMO small-cell base stations to perform either closed-loop MIMO transmission or diversity combining. The main difference is that a repeater performs amplify and forward, while a multi-user MIMO relay performs decode and forward, and can generate pilots. Repeaters and relays perform only physical-layer functions. Full-fledged small-cell base stations perform L1 and L2 functions in the data-plane and control-plane functions. The benefit is that repeaters and relays will not be limited in their designed processing capacity to the processing capacity of full-fledged small-cell base stations (e.g., 32 simultaneously users). In either case, the macrocell BS is in charge of control-protocol processing and baseband processing, and there are significant multiplexing gains among the repeaters and relays.

There are two closed-loop beamforming options for the macrocell BS. The first beamforming option is for the macrocell BS to beamform to the mobile devices through the small-cell BSs. The second beamforming option is for the macrocell BS to beamform to the small-cell BSs only. For the first beamforming option, the macrocell BS can schedule the mobile devices to transmit pilot signals. Different small-cell BSs can use the same pilot signals at the same time. The macrocell BS will estimate the composite channel. Because it has different backhaul channels, the macrocell BS can distinguish between (i) channels for the mobile devices and (ii) channels for the small-cell BSs. For the second beamforming option, the macrocell BS adapts the coding rate based on SINR (signal-to-interference-and-noise ratio) estimations without explicit channel estimates. For both beamforming options, the macrocell BS transmits pilot signals to the small-cell BSs, where each small-cell BS can determine whether or not it needs to repeat the pilot signal. For example, using analog correlation circuits, a small-cell BS can determine whether the pilot signal is intended for it or not. Note that these transmissions are not full-duplex transmissions, where the uplink and downlink signals are transmitted using the same frequency at the same time. Rather, the pilot signal is repeated after a delay. The delay of signal is very short (less than 1 microsecond) if the delay circuitry is implemented in the analog domain. Because of this, the pilot is not transmitted continuously. The pilot is split into a number of transmissions with fixed gaps in between. Within the gaps, the repeater repeats the signals.

As used in this specification, a relay, such as relay 122 of FIG. 1, is type of a small-cell BS that is capable of originating uplink pilot signal transmissions to a macrocell BS, such as LSAS BS 112 of FIG. 1, while a repeater, such as repeater 132 of FIG. 1, is a type of small-cell BS that is incapable of originating uplink pilot signal transmissions to a macrocell BS. Instead, a repeater merely re-transmits back to the macrocell BS, a downlink pilot signal that the repeater receives from the macrocell BS. As described further below, the processing involved in estimating the CSI data for backhaul channels between a macrocell BS and a relay is different from the processing involved in estimating the CSI data for backhaul channels between a macrocell BS and a repeater.

In communication system 100 of FIG. 1, relay 122 and repeater 132 use the same air interface as the access link to the mobile devices 102. A relay is a small-cell BS that can decode, re-encode, and forward its received signal, while a repeater simply forwards its received signal without decoding and re-encoding. Relays and repeaters are less expensive to deploy than full-fledged small-cell base stations.

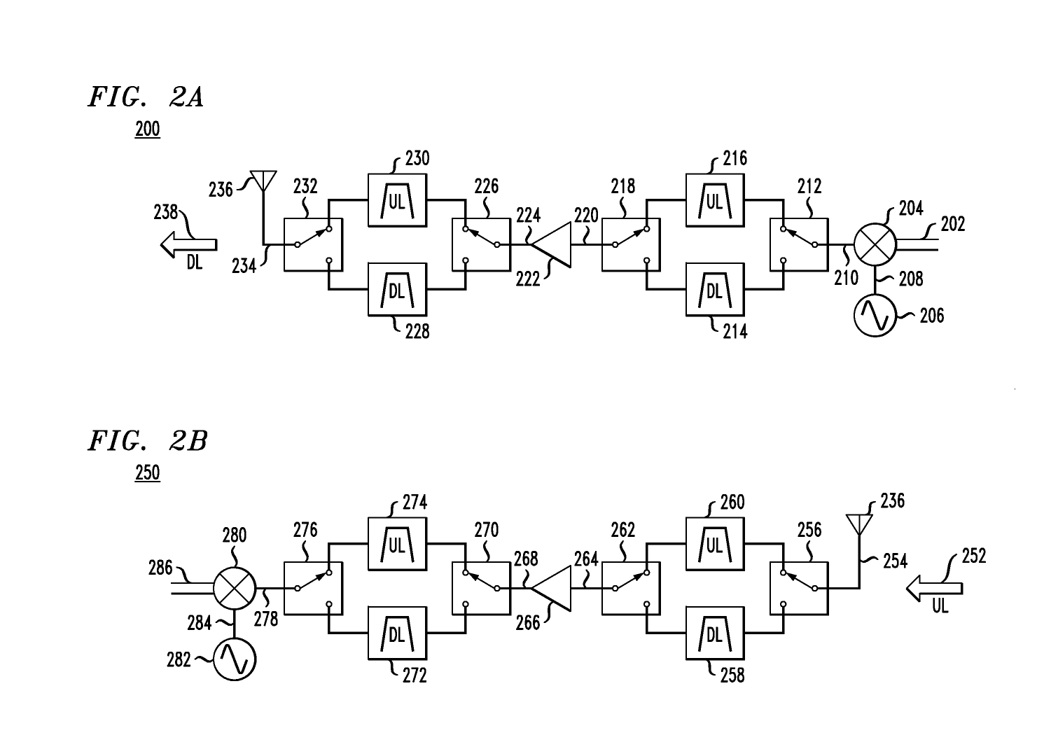

FIG. 2A is a simplified block diagram representing the analog signal-processing portion of the configurable transmit (TX) chain 200 of one of the transceivers of LSAS BS 112 of FIG. 1, while FIG. 2B is a simplified block diagram representing the analog signal-processing portion of the configurable receive (RX) chain 250 of that transceiver. The configurable TX chain 200 can be selectively configured to transmit downlink signals in either a downlink frequency band (DL FB1) or a (different) uplink frequency band (UL FB2), while the configurable RX chain 250 can be selectively configured to receive uplink signal in either the DL FB1 or the UL FB2. In one implementation, LSAS BS 112 has one such transceiver for each LSAS antenna. In another implementation, only one LSAS antenna has such a transceiver, while each other LSAS antenna in the LSAS BS has a configurable RX chain 250, but a conventional non-configurable TX chain that can transmit downlink signals in only the DL FB1.

Referring to FIG. 2A, LSAS TX chain 200 includes an IQ vector modulator 204 which modulates and upconverts the analog baseband output 202 of an upstream digital-to-analog converter (DAC, not shown) based on an LO signal 208 generated by local oscillator (LO) 206. The resulting RF signal 210 is applied to (1×2) switch 212, which selectively directs the RF signal towards either RF TX filter 214 or RF TX filter 216. RF TX filter 214 is a band-pass filter that filters out signals outside of a downlink frequency band (DL FB1), while RF TX filter 216 is a band-pass filter that filters out signals outside of an uplink frequency band (UL FB2) that is different from DL FB1. In either case, the resulting filtered RF signal is directed by (2×1) switch 218 to power amplifier 222, which amplifies the filtered RF signal 220 to generate amplified RF signal 224.

Amplified RF signal 224 is applied to (1×2) switch 226, which selectively directs the amplified RF signal towards either RF TX filter 228 or RF TX filter 230. RF TX filter 228 is a band-pass filter that filters out signals outside of DL FB1, while RF TX filter 230 is a band-pass filter that filters out signals outside of UL FB2. In either case, the resulting filtered RF signal is directed by (2×1) switch 232 to LSAS antenna 236, which transmits the filtered RF signal 234 in the downlink direction as an RF downlink signal 238.

To configure LSAS TX chain 200 to generate the RF downlink signal 238 in DL FB1, switches 212, 218, 226, and 232 are all configured to select the lower poles shown in FIG. 2A. Similarly, to configure LSAS TX chain 200 to generate the RF downlink signal 238 in UL FB2, switches 212, 218, 226, and 232 are all configured to select the upper poles shown in FIG. 2A.

Referring to FIG. 2B, LSAS RX chain 250 includes LSAS antenna 236 of FIG. 2A, which receives an RF uplink signal 252 and applies the received RF signal 254 to a (1×2) switch 256, which selectively directs the received RF signal towards either RF RX filter 258 or RF RX filter 260. RF RX filter 258 is a band-pass filter that filters out signals outside of DL FB1, while RF RX filter 260 is a band-pass filter that filters out signals outside of UL FB2. In either case, the resulting filtered RF signal is directed by (2×1) switch 262 to low-noise amplifier (LNA) 266, which amplifies the filtered RF signal 264 to generate amplified RF signal 268.

Amplified RF signal 268 is applied to (1×2) switch 270, which selectively directs the amplified RF signal towards either RF RX filter 272 or RF RX filter 274. RF RX filter 272 is a band-pass filter that filters out signals outside of DL FB1, while RF TX filter 274 is a band-pass filter that filters out signals outside of UL FB2. In either case, the resulting filtered RF signal 278 is directed by (2×1) switch 276 to IQ vector demodulator 280, which demodulates and downconverts the filtered RF signal based on LO signal 284 from local oscillator 282 to generate analog baseband signal 286 suitable for application to a downstream analog-to-digital converter (ADC, not shown).

To configure LSAS RX chain 250 to receive the RF uplink signal 252 in DL FB1, switches 256, 262, 270, and 276 are all configured to select the lower poles shown in FIG. 2B. Similarly, to configure LSAS RX chain 250 to receive the RF uplink signal 252 in UL FB2, switches 256, 262, 270, and 276 are all configured to select the upper poles shown in FIG. 2B.

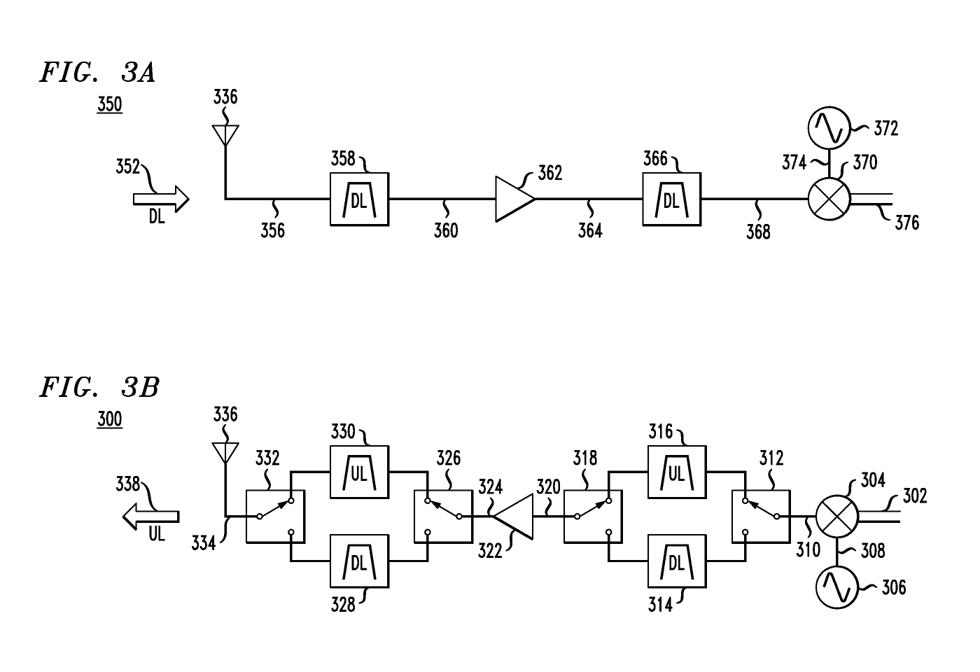

FIG. 3A is a simplified block diagram representing the analog signal-processing portion of the RX chain 350 of a transceiver of relay 122 of FIG. 1, while FIG. 3B is a simplified block diagram representing the analog signal-processing portion of the TX chain 300 of that transceiver. Relay 122 has one such transceiver for each relay antenna.

Referring to FIG. 3A, relay RX chain 350 includes relay antenna 336, which receives an RF downlink signal 352 and applies the received RF signal 356 to an RF RX filter 358, which is a band-pass filter that filters out signals outside of DL FB1. The resulting filtered RF signal 360 is applied to LNA 362, which amplifies the filtered RF signal to generate amplified RF signal 364, which is applied to RF RX filter 366, which is a band-pass filter that filters out signals outside of DL FB1. The resulting filtered RF signal 368 is applied to IQ vector demodulator 370, which demodulates and downconverts the filtered RF signal based on LO signal 374 from local oscillator 372 to generate analog baseband signal 376 suitable for application to a downstream ADC (not shown). As represented in FIG. 3A, relay RX chain 350 is capable of receiving downlink signal 352 only in DL FB1.

Referring to FIG. 3B, relay TX chain 300 is analogous to LSAS TX chain 200 of FIG. 2A, with analogous elements and analogous signals having analogous labels 302-338, except that relay TX chain 300 generates a filtered signal 334 that is transmitted by relay antenna 336 as RF uplink signal 338.

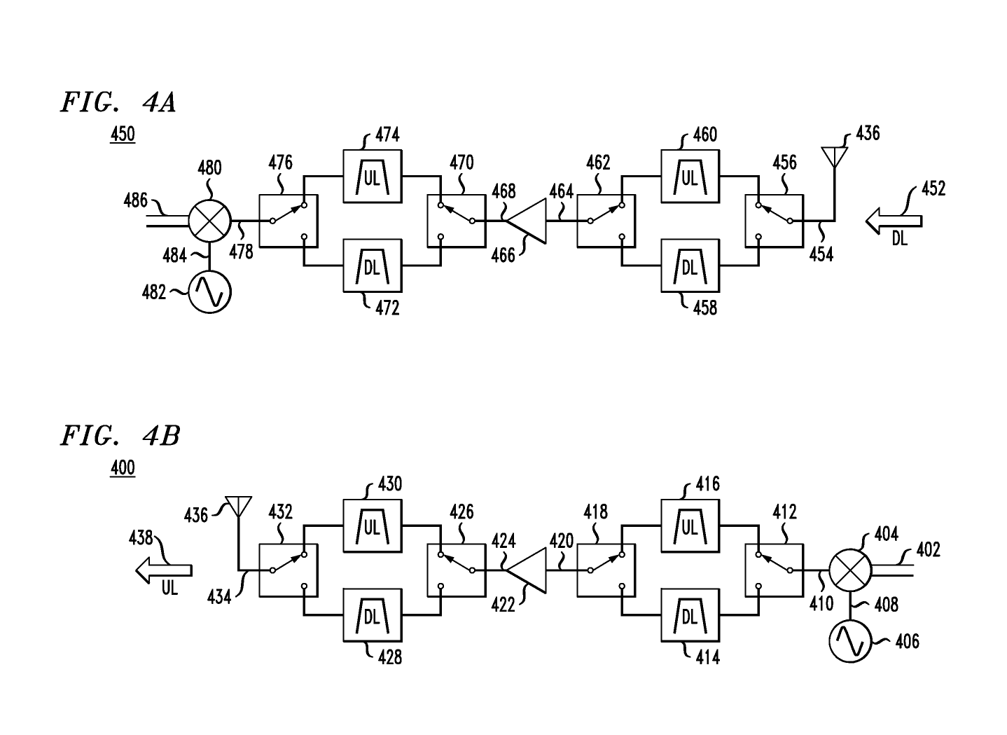

FIG. 4A is a simplified block diagram representing the analog signal-processing portion of the RX chain 450 of a transceiver of repeater 132 of FIG. 1, while FIG. 4B is a simplified block diagram representing the analog signal-processing portion of the TX chain 400 of that transceiver. Repeater 132 has one such transceiver for each repeater antenna.

Referring to FIG. 4A, repeater RX chain 450 is analogous to LSAS RX chain 250 of FIG. 2B, with analogous elements and analogous signals having analogous labels 452-486, except that repeater RX chain 450 receives an RF downlink signal 452.

Referring to FIG. 4B, repeater TX chain 400 is analogous to LSAS TX chain 200 of FIG. 2A, with analogous elements and analogous signals having analogous labels 402-438, except that repeater TX chain 400 generates a filtered signal 434 that is transmitted by repeater antenna 436 as RF uplink signal 438.

As described above, RF TX filters 214, 228, 314, 328, 414, and 428 and RF RX filters 258, 272, 358, 366, 458, and 472 of FIGS. 2-4 are band-pass filters that filter out signals outside of DL FB1, while RF TX filters 216, 230, 316, 330, 416, and 430 and RF TX filters 260, 274, 460, and 474 of FIGS. 2-4 are band-pass filters that filter out signals outside of UL FB2. The RF filtering functions have many purposes, but in general the main reason is to inhibit the TX signals (both in the TX band and the wideband noise floor in the RX band) from desensitizing/distorting the receiver. In addition, the RF TX filters help eliminate any spurious or harmonic responses from radiating out the antennas. The RF RX filters also help reduce RF interferers that may overload or distort the receiver.

In the embodiments of FIGS. 3 and 4, the relay/repeater downconverts an RF input signal into a baseband signal that is processed digitally (to do additional filtering, for instance). Subsequently, the processed baseband signal is upconverted back to RF and reradiated out of the antenna. It should be noted that this is just one of a number of different signal processing approaches that could be taken. For example, a repeater could just amplify and reradiate the RF input signal without downconverting to do additional baseband processing. Therefore, it should be clear that the embodiments of FIGS. 3 and 4 are typical methods but not the only methods.

Furthermore, in the embodiments described above apply for the case in FIG. 1 where all the links (between the LSAS BS and the repeaters/relays and between the repeaters/relays and the mobile UEs) are in the same RF frequency band. This does not necessarily need to be the case, and one could in principle use different frequency bands for different links. In this case, a repeater may have an additional mixing stage to shift frequencies from input to output.

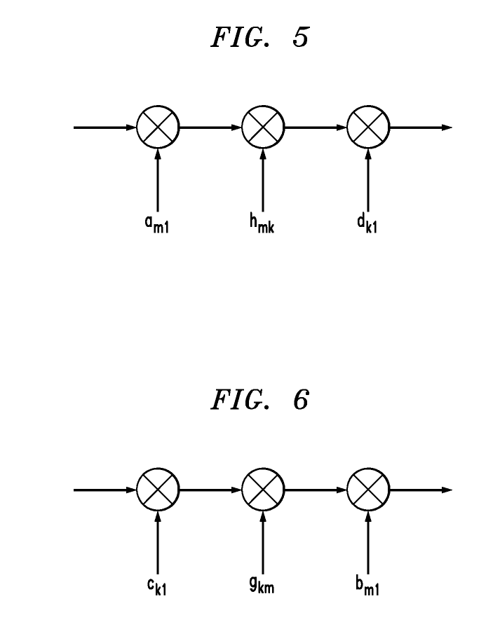

FIG. 5 is a block diagram representing the overall downlink channel ĥₘₖ₁ for downlink transmissions from LSAS antenna m to small-cell antenna k in DL FB1, while FIG. 6 is a block diagram representing the overall uplink channel ĝₖₘ₁ for uplink transmissions from small-cell antenna k to LSAS antenna m in DL FB1.

The downlink channel ĥₘₖ₁ of FIG. 5 in DL FB1 can be represented according to Equation (1) as follows:

ĥₘₖ₁=aₘ₁·hₘₖ₁·dₖ₁, (1)

where:

aₘ₁ is the frequency response of the analog TX chain 200 for LSAS antenna m in DL FB1, which corresponds to elements 204, 212, 214, 218, 222, 226, 228, E232, and 236 of FIG. 2A;

hₘₖ₁ is the frequency response of the air link from LSAS antenna m to small-cell antenna k in DL FB1; and

dₖ₁ is the frequency response of the analog RX chain for small-cell antenna k in DL FB1, which corresponds to (i) elements 336, 358, 362, 366, and 370 of FIG. 3A when the small-cell BS is relay 122 of FIG. 1 and to (ii) elements 436, 456, 458, 462, 466, 470, 472, 476, and 480 of FIG. 4A when the small-cell BS is repeater 132 of FIG. 1.

Similarly, the uplink channel ĝₖₘ₁ of FIG. 6 in DL FB1 can be represented according to Equation (2) as follows:

ĝₖₘ₁=cₖ₁·gₖₘ₁·bₘ₁, (2)

where:

cₖ₁ is the frequency response of the analog TX chain for small-cell antenna k in DL FB1, which corresponds to (i) elements 304, 312, 314, 318, 322, 326, 328, 332, and 336 of FIG. 3B when the small-cell BS is relay 122 of FIG. 1 and to (ii) elements 404, 412, 414, 418, 422, 426, 428, 432, and 436 of FIG. 4B when the small-cell BS is repeater 132 of FIG. 1;

gₖₘ₁ is the frequency response of the air link from small-cell antenna k to LSAS antenna m in DL FB1; and

bₘ₁ is the frequency response of the analog RX chain for LSAS antenna m in DL FB1, which corresponds to elements 236, 256, 258, 262, 266, 270, 272, 276, and 280 of FIG. 2B.

Although not shown in figures analogous to FIGS. E and F, the overall downlink channel hₘₖ₂ for downlink transmissions from LSAS antenna m to small-cell antenna k in UL FB2 can be represented according to Equation (3) as follows:

ĥₘₖ₂=aₘ₂·hₘₖ₂·dₖ₂, (3)

where:

aₘ₂ is the frequency response of the analog TX chain for LSAS antenna m in UL FB2, which corresponds to elements 204, 212, 216, 218, 222, 226, 230, 232, and 236 of FIG. 2A;

hₘₖ₂ is the frequency response of the air link from LSAS antenna m to small-cell antenna k in UL FB2; and

dₖ₂ is the frequency response of the analog RX chain for small-cell antenna k in UL FB2, which corresponds to elements 436, 456, 460, 462, 466, 470, 474, 476, and E480 of FIG. 4A when the small-cell BS is repeater 132 of FIG. 1. Note that relay 122 of FIG. 1 does not receive and process signals in UL FB2.

Similarly, the overall uplink channel ĝₖₘ₂ for uplink transmissions from small-cell antenna k to LSAS antenna m in UL FB2 can be represented according to Equation (4) as follows:

ĝₖₘ₂=cₖ₂·gₖₘ₂·bₘ₂, (4)

where:

cₖ₂ is the frequency response of the analog TX chain for small-cell antenna k in UL FB2, which corresponds to (i) elements 304, 312, 316, 318, 322, 326, 330, 332, and 336 of FIG. 3B when the small-cell BS is relay 122 of FIG. 1 and to (ii) elements 404, 412, 416, 418, 422, 426, 430, 432, and 436 of FIG. 4B when the small-cell BS is repeater 132 of FIG. 1;

gₖₘ₂ is the frequency response of the air link from small-cell antenna k to LSAS antenna m in UL FB2; and

bₘ₂ is the frequency response of the analog RX chain for LSAS antenna m in UL FB2, which corresponds to elements 236, 256, 260, 262, 266, 270, 274, 276, and 280 of FIG. 2B.

According to certain embodiments, LSAS BS 112 needs estimates of (i) the downlink channel ĥₘₖ₁ in DL FB1 for downlink transmissions from each LSAS antenna m and each relay antenna k and (ii) the uplink channel ĝₖₘ₂ in UL FB2 for uplink transmissions from each relay antenna k to each LSAS antenna m in order for LSAS BS 112 of FIG. 1 to communicate effectively with relay 122.

### Channel Estimation for Relays

As described previously, a relay is a type of small-cell BS that is capable of initiating the transmission of pilot signals. According to one technique, FDD transmissions between a macrocell BS, such as LSAS BS 112 of FIG. 1, and a relay, such as relay 122 of FIG. 1, are enabled based on (i) estimations of the uplink channels from the relay to the macrocell BS in both the downlink frequency band DL FB1 and the uplink frequency band UL FB2 and (ii) relative calibration data for the TX and RX chains in the macrocell BS for DL FB1.

Downlink Transmissions to Relays

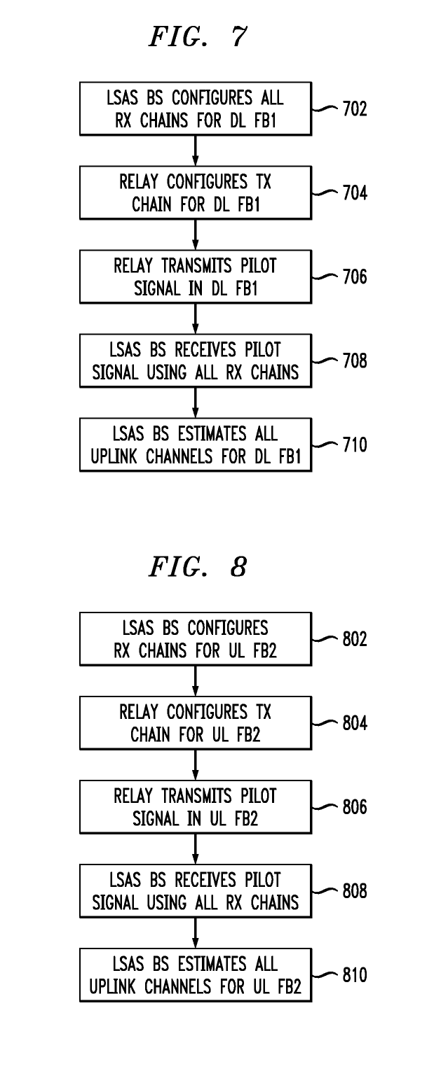

FIG. 7 is a flow diagram of a method for estimating all M uplink channels ĝₖₘ₁, m=1, . . . , M, in DL FB1 from relay antenna k of relay 122 of FIG. 1 to the M antennas m of LSAS BS 112 for use in transmitting downlink data signals from the LSAS BS to the relay. In step 702, LSAS BS 112 configures all M RX chains 250ₘ, m=1, . . . , M, of FIG. 2B for its M LSAS antennas to receive uplink RF signals in DL FB1. In step 704, relay 122 configures its TX chain 300ₖ of FIG. 3B for relay antenna k to generate uplink RF signal 338 in DL FB1.

In step 706, relay 122 uses TX chain 300ₖ associated with relay antenna 336ₖ to transmit a pilot signal s in DL FB1. In step 708, LSAS BS 112 uses all M of its RX chains 250ₘ associated with its M LSAS antennas 236ₘ to receive the transmitted pilot signal from relay 122.

In step 710, LSAS BS 112 estimates the uplink channel ĝₖₘ₁ for uplink transmissions from relay antenna k to each LSAS antenna m for DL FB1. The signal yₘ received and processed by RX chain 250ₘ of LSAS BS 112 is given by Equation (5) as follows:

yₘ=ĝₖₘ₁s. (5)

As such, LSAS BS 112 can estimate the uplink channels ĝₖₘ₁ for uplink transmissions from relay antenna k to each LSAS antenna m for DL FB1 according to Equation (6) as follows:

ĝₖₘ₁=s/yₘ. (6)

If relay 122 has more than one antenna, then the method of FIG. 7 is repeated for each other relay antenna.

LSAS BS 112 generates downlink data signals for relay 122 by pre-coding user data stream d based on the estimated uplink channels ĝₖₘ₁ for DL FB1 of Equation (5) and relative TX/RX calibration data for the TX and RX chains of LSAS BS 112. In particular, for the downlink channel from LSAS antenna m to relay antenna k, the user data stream q is multiplied by Cₘ₁ĝₖₘ₁*, where ĝₖₘ₁ is the complex conjugate of the estimated uplink channel ĝₖₘ₁ of Equation (6), and Cₘ₁ is the relative TX/RX calibration data given by Equation (7) as follows:

$${C}_{m 1} = \frac{{b}_{m 1}}{{a}_{m 1}} \frac{{a}_{11}}{{b}_{11}} , \qquad ( 7 )$$

where aᵢ₁ is the frequency response of TX chain 200 of FIG. 2A for LSAS antenna i for DL FB1 and bᵢ₁ is the frequency response of RX chain 250 of FIG. 2B for LSAS antenna i for DL FB1. The generation of the relative TX/RX calibration data is described further below.

With its TX chains 200 of FIG. 2 configured to DL FB1, LSAS BS 112 transmits the M generated downlink signals using its M antennas, and relay 122 receives the superposition of those downlink signals at its antenna k as received signal yₖ given by Equation (8) as follows:

$${y}_{k} = {\sum }_{m = 1}^{M} {C}_{m 1} {\hat{g}}_{km 1}^{*} {\hat{h}}_{mk 1} q + {n}_{k} , \qquad ( 8 )$$

where ĥₘₖ₁ is the downlink channel from LSAS antenna m to relay antenna k and nₖ is the noise and interference at relay antenna k.

Substituting Equations (1), (2), and (7) into Equation (8) and recognizing that, due to the reciprocity of the air link, hₘₖ₁=gₖₘ₁, yields Equation (9) as follows:

$${y}_{k} = ( \frac{{a}_{11}}{{b}_{11}} {d}_{k 1} {c}_{k 1}^{*} ) q {\sum }_{m = 1}^{M} {\vert {b}_{m 1} \vert}^{2} {\vert {g}_{km 1} \vert}^{2} + {n}_{k} , \qquad ( 9 )$$

where

$$( \frac{{a}_{11}}{{b}_{11}} {d}_{k 1} {c}_{k 1}^{*} )$$

is a constant, unknown term with a phase rotation and a magnitude change. As indicated by Equation (9), all M downlink signals will add coherently at relay antenna k. The phase-rotation/magnitude-change term in Equation (9) will not be an issue for standards such as LTE that typically have pilot subcarriers for demodulation. Demodulation reference pilot signals correct phases and magnitudes due to channel estimation error, frequency offsets due to clock, etc.

Uplink Transmissions from Relays

FIG. 8 is a flow diagram of a method for estimating all M uplink channels ĝₖₘ₂, m=1, . . . , M, in UL FB2 for uplink transmissions from relay antenna k to LSAS BS 112. In step 802, LSAS BS 112 configures the RX chains 250 for all M of its LSAS antennas 236 to receive uplink RF signal 252 in UL FB2. In step 804, relay 122 configures its TX chain 300ₖ for relay antenna 336ₖ to generate uplink RF signal 338 in UL FB2.

In step 806, relay 122 uses TX chain 300ₖ associated with relay antenna 336ₖ to transmit a pilot signal s in UL FB2. In step 808, LSAS BS 112 uses all M of its RX chains 250ₘ associated with its M LSAS antennas 236ₘ to receive the transmitted pilot signal from relay 122.

In step 810, LSAS BS 112 estimates the uplink channel ĝₖₘ₂ for uplink transmissions from relay antenna k to each LSAS antenna m for UL FB2. The signal yₘ received and processed by RX chain 250ₘ of LSAS BS 112 is given by Equation (10) as follows:

yₘ=ĝₖₘ₂s. (10)

As such, LSAS BS 112 can estimate the uplink channels ĝₖₘ₂ for uplink transmissions from relay antenna k to each LSAS antenna m for UL FB2 according to Equation (11) as follows:

ĝₖₘ₂=s/yₘ. (11)

If relay 122 has more than one antenna, then the method of FIG. 8 is repeated for each other relay antenna. After the method of FIG. 8 has been completed for each relay antenna, the LSAS BS 112 will have estimated all of the uplink channels ĝₖₘ₂ for uplink transmissions between the one or more relay antennas of relay 122 and the M LSAS antennas in UL FB2. At this point, after configuring all relay TX chains 300 of FIG. 3B and all LSAS RX chains 250 of FIG. 2B for UL FB2, relay 122 will be able to successfully transmit uplink data signals to LSAS BS 112 with LSAS BS 112 decoding each received signal based on the corresponding estimated uplink channel ĝₖₘ₂ of Equation (11).

### Channel Estimation for Repeaters

As described previously, a repeater is a type of small-cell BS that is not capable of initiating the transmission of pilot signals. As such, in order to estimate channels for repeaters, the LSAS BS initiates the transmission of pilot signals to the repeater, which receives and re-transmits the received pilot signals back to the LSAS BS. According to one technique, FDD transmissions between a macrocell BS, such as LSAS BS 112 of FIG. 1, and a repeater, such as repeater 132 of FIG. 1, are enabled based on (i) estimated channel data in both the downlink frequency band DL FB1 and the uplink frequency band UL FB2 and (ii) relative calibration data for the TX and RX chains in the macrocell BS for DL FB1.

Downlink Transmissions to Repeaters

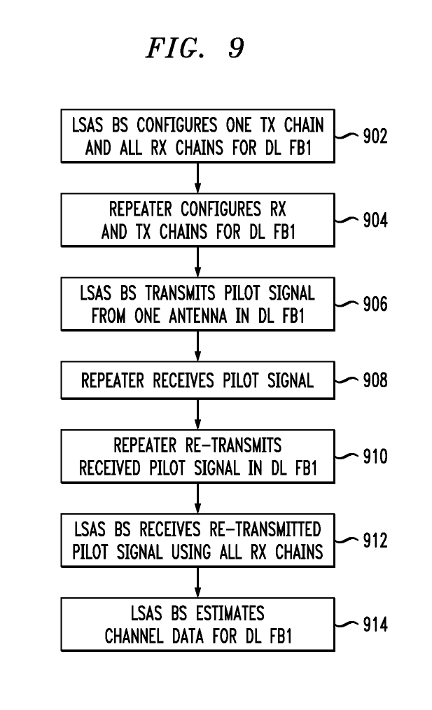

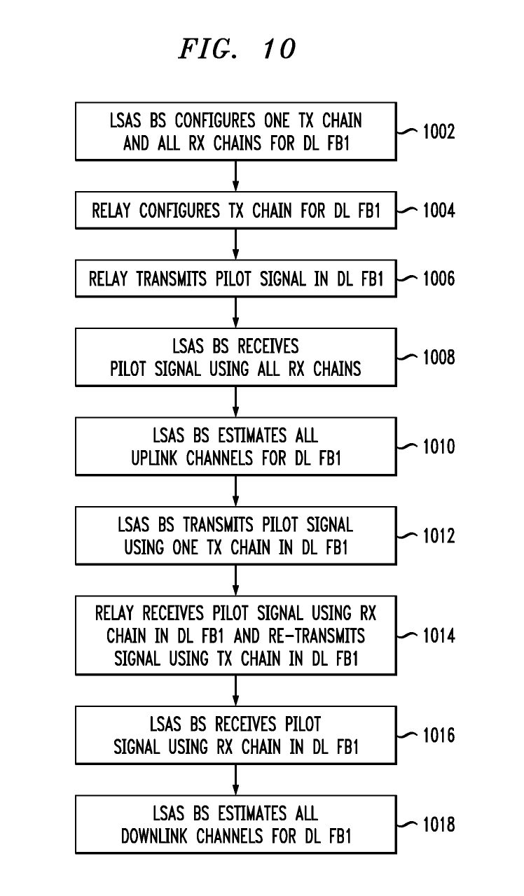

FIG. 9 is a flow diagram of a method for estimating channel data for use in transmitting downlink data signals from LSAS BS 112 to the repeater 132. To achieve this result, LSAS BS 112 uses one of its antennas (e.g., LSAS antenna m=1) to transmit a pilot signal in DL FB1. Repeater 132 receives the pilot signal at its repeater antenna k and re-transmits the received pilot signal in DL FB1 from its repeater antenna k. LSAS BS 112 receives the re-transmitted pilot signal at all M of its antennas and processes those signals to generate estimated channel data for transmitting downlink data signals

In step 902, LSAS BS 112 configures (i) its TX chain 200₁ of FIG. 2A for LSAS antenna 236₁ to generate downlink RF signal 238₁ in DL FB1 and (ii) all M RX chains 250ₘ, m=1, . . . , M, of FIG. 2B to receive uplink RF signals 252ₘ in DL FB1. In step 904, repeater 132 configures (i) its RX chain 450ₖ of FIG. 4A to receive downlink RF signal 452 in DL FB1 and (ii) its TX chain 400ₖ of FIG. 4B to generate uplink RF signal 438 in DL FB1.

In step 906, LSAS BS 112 uses TX chain 200₁ to transmit a pilot signal s in DL FB1. In step 908, repeater 132 uses RX chain 450ₖ to receive the transmitted pilot signal from LSAS BS 112. In step 910, repeater 132 uses TX chain 400ₖ to re-transmit the received pilot signal in DL FB1. In step 912, LSAS BS 112 uses all M of its RX chains 250ₘ associated with its M LSAS antennas 236ₘ to receive the re-transmitted pilot signal from repeater 132.

In step 914, LSAS BS 112 estimates channel data for DL FB1. The signal yₘ received and processed by RX chain 250ₘ of LSAS BS 112 is given by Equation (12) as follows:

yₘ=ĝₖₘ₁ĥ₁ₖ₁s, (12)

where ĥ₁ₖ₁ is the downlink channel from LSAS antenna 236₁ to repeater antenna k in the DL FB1, and ĝₖₘ₁ is the uplink channel from repeater antenna k to LSAS antenna 236ₘ. As such, LSAS BS 112 can estimate the round-trip channel a ĝₖₘ₁ĥ₁ₖ₁ for the round trip consisting of (i) the downlink pilot transmission from LSAS antenna 236₁ to repeater antenna k in DL FB1 and (ii) the uplink pilot re-transmission from repeater antenna k to LSAS antenna 236ₘ in DL FB1 according to Equation (13) as follows:

ĝₖₘ₁ĥ₁ₖ₁=yₘ/s. (13)

If repeater 132 has more than one antenna, then the method of FIG. 9 is repeated for each other repeater antenna.

LSAS BS 112 generates downlink data signals for repeater 132 by pre-coding user data stream q based on the estimated channel data a ĝₖₘ₁ĥ₁ₖ₁ for DL FB1 of Equation (13) and relative TX/RX calibration data for the TX and RX chains of LSAS BS 112. In particular, for the downlink channel from LSAS antenna m to repeater antenna k, the user data stream q is multiplied by Cₘ₁ĝₖₘ₁*ĥ₁ₖ₁*, where ĝₖₘ₁*ĥ₁ₖ₁* is the complex conjugate of the estimated channel data a ĝₖₘ₁ĥ₁ₖ₁ of Equation (13), and Cₘ₁ is the relative TX/RX calibration data given previously by Equation (7).

With its TX chains 200 of FIG. 2 configured to DL FB1, LSAS BS 112 transmits the M generated downlink data signals using its M antennas, and repeater 132 receives the superposition of those downlink data signals at its antenna k as received signal yₖ given by Equation (14) as follows:

$${y}_{k} = {\sum }_{m = 1}^{M} {C}_{m 1} {\hat{g}}_{km 1}^{*} {\hat{h}}_{1 k 1}^{*} {\hat{h}}_{mk 1} q + {n}_{k} , \qquad ( 14 )$$

where ĥₘₖ₁ is the downlink channel from LSAS antenna m to repeater antenna k and nₖ is the noise and interference at repeater antenna k.

Substituting Equations (1), (2), and (7) into Equation (14) and recognizing that, due to the reciprocity of the air link, hₘₖ₁=gₖₘ₁, yields Equation (15) as follows:

$${y}_{k} = {\vert {a}_{11} \vert}^{2} {\vert {d}_{k 1} \vert}^{2} ( \frac{{h}_{1 k}^{*}}{{b}_{11}} {c}_{k 1}^{*} ) q {\sum }_{m = 1}^{M} {\vert {b}_{m 1} \vert}^{2} {\vert {g}_{km 1} \vert}^{2} + {n}_{k} , \qquad ( 15 )$$

where

$${\vert {a}_{11} \vert}^{2} {\vert {d}_{k 1} \vert}^{2} ( \frac{{h}_{1 k}^{*}}{{b}_{11}} {c}_{k 1}^{*} )$$

is a constant, unknown term with a phase rotation and a magnitude change. As indicated by Equation (15), all M downlink signals will add coherently at repeater antenna k. The phase-rotation/magnitude-change term in Equation (15) will not be an issue for standards such as LTE that typically have pilot subcarriers for demodulation. Demodulation reference pilot signals correct phases and magnitudes due to channel estimation error, frequency offsets due to clock, etc.

Uplink Transmissions from Repeaters

The method for estimating channel data for uplink transmissions from each repeater antenna in UL FB2 is analogous to the method of FIG. 9 shown for downlink transmissions in DL FB1 except that the TX and RX chains are configured to generate and receive RF signals in UL FB2 instead of DL FB1. After the method has been completed for each repeater antenna, the LSAS BS 112 will have estimated channel data ĝₖₘ₂ĥ₁ₖ₂ for uplink transmissions between the one or more repeater antennas k of repeater 132 and the M LSAS antennas m in UL FB2. At this point, after configuring all repeater TX chains 300 of FIG. 3B and all LSAS RX chains 250 of FIG. 2B for UL FB2, repeater 132 will be able to successfully transmit uplink data signals to LSAS BS 112 with LSAS BS 112 decoding each received signal based on the corresponding estimated channel data as follows.

For conjugate beamforming, the conjugate of each uplink channel estimate from each repeater antenna is applied at each LSAS antenna, and the sum of all the decoded signals from each repeater is then decoded. For zero forcing, the weights are from pseudo-inverses of the uplink channel estimates.

Although the uplink channel estimation for repeaters has been described in the context of the repeater repeating a pilot signal received from the LSAS BS, in another embodiment, a repeater repeats a pilot signal received from a UE.

Downlink Channel Estimation for Relays without Phase/Magnitude Correction Pilots

When phase/magnitude-correction pilot signals are not present, FDD transmission between LSAS BS 112 and relay 122 can still be supported. The estimation of the uplink channels for uplink data transmissions in UL FB2 can still be implemented using the method of FIG. 8. The following method can be used to estimate the downlink channels for downlink data transmission in DL FB1.

FIG. 10 is a flow diagram of a method for estimating all M downlink channels ĥₘₖ₁=1, . . . , M, in DL FB1 from LSAS BS 112 to relay antenna k. In step 1002, LSAS BS 112 configures the TX chain 200 (e.g., TX chain 200₁) for one of its LSAS antennas 236 (e.g., LSAS antenna 236₁) to generate downlink RF signal 238 in DL FB1. In step 1002, LSAS BS 112 also configures all M RX chains 250ₘ, m=1, . . . , M, for its M LSAS antennas to receive uplink RF signals in DL FB1. In step 1004, relay 122 configures its TX chain 300ₖ for relay antenna k to generate uplink RF signal 338 in DL FB1.

In step 1006, relay 122 uses TX chain 300ₖ associated with relay antenna 336ₖ to transmit a pilot signal s in DL FB1. In step 1008, LSAS BS 112 uses all M of its RX chains 250ₘ associated with its M LSAS antennas 236ₘ to receive the transmitted pilot signal from relay 122.

In step 1010, LSAS BS 112 estimates the uplink channel ĝₖₘ₁ for uplink transmissions from relay antenna k to each LSAS antenna m for DL FB1. The signal yₘ received and processed by RX chain 250ₘ of LSAS BS 112 is given by Equation (16) as follows:

yₘ=ĝₖₘ₁s. (16)

As such, LSAS BS 112 can estimate the uplink channels ĝₖₘ₁ for uplink transmissions from relay antenna k to each LSAS antenna m for DL FB1 according to Equation (17) as follows:

ĝₖₘ₁=s/yₘ. (17)

In step 1012, LSAS BS 112 uses TX chain 200₁ to transmit a (different or same) pilot signal sin DL FB1 from LSAS antenna 236₁. In step 1014, relay 122 uses RX chain 350ₖ associated with relay antenna 336ₖ to receive the transmitted pilot signal from LSAS BS 112 and then uses TX chain 300ₖ associated with relay antenna 336ₖ to re-transmit the received pilot signal in DL FB1. In step 1016, LSAS BS 112 uses all M of its RX chains 250ₘ associated with its M LSAS antennas 236ₘ to receive the re-transmitted pilot signal from relay 122.

In step 1018, LSAS BS 112 estimates the downlink channel ĥₘₖ₁ for downlink transmissions from each LSAS antenna m to relay antenna k in DL FB1. The signal yₘ received and processed by RX chain 250ₘ of LSAS BS 112 is given by Equation (18) as follows:

yₘ=ĝₖₘ₁ĥ₁ₖ₁s, (18)

where ĥ₁ₖ₁ is the downlink channel for downlink transmissions from LSAS antenna 236₁ to relay antenna k in the DL FB1. As such, LSAS BS 112 can estimate the downlink channel ĥ₁ₖ₁ for downlink transmissions from LSAS antenna 236₁ to relay antenna k in DL FB1 according to Equation (19) as follows:

ĥ₁ₖ₁=y₁/ĝₖ₁₁s, (19)

where y₁ is the signal received and processed by RX chain 250₁ of LSAS BS 112, and a ĝₖ₁₁ is the uplink channel for uplink transmissions from relay antenna k to LSAS antenna 236₁ in DL FB1, which is known from Equation (17).

According to Equation (1), the downlink channel ĥ₁ₖ₁ in DL FB1 can be represented according to Equation (20) as follows:

ĥₘₖ₁=aₘ₁·hₘₖ₁·dₖ₁. (20)

Similarly, the downlink channel ĥₘₖ₁, m≠1, for the other M−1 LSAS antennas in DL FB1 can be represented according to Equation (21) as follows:

ĥₘₖ₁=aₘ₁·hₘₖ₁·dₖ₁. (21)

Since dₖ₁ is in both Equations (20) and (21), those equations can be solved for dₖ₁ and then set equal to one another to yield Equation (22) as follows:

$$\frac{{\hat{h}}_{1 k 1}}{{a}_{11} \cdot {h}_{1 k 1}} = \frac{{\hat{h}}_{mk 1}}{{a}_{m 1} \cdot {h}_{mk 1}} . \qquad ( 22 )$$

Solving Equation (22) for ĥₘₖ₁ yields Equation (23) as follows:

$${\hat{h}}_{mk 1} = \frac{{\hat{h}}_{1 k 1} \cdot {a}_{m 1} \cdot {h}_{mk 1}}{{a}_{11} \cdot {h}_{1 k 1}} , \qquad ( 23 )$$

where ĥ₁ₖ₁ is known from Equation (19). Assuming that the frequency response h₁ₖ₁ of the air link from LSAS antenna m=1 to relay antenna k is identical to the frequency response hₘₖ₁ of the air link from each LSAS antenna m≠1 to relay antenna k, Equation (23) reduces to Equation (24) as follows:

$${\hat{h}}_{mk 1} = \frac{{\hat{h}}_{1 k 1} \cdot {a}_{m 1}}{{a}_{11}} , \qquad ( 24 )$$

where aₘ₁/a₁₁ is the relative frequency response of LSAS TX chain 200ₘ to LSAS TX chain 200₁. If relative calibration is intermittently performed on the M LSAS TX chains 200ₘ, then LSAS BS 112 can use Equation (24) to estimate the M−1 other downlink channels ĥₘₖ₁ in DL FB1, and step 1018 of FIG. 10 will be completed.

If relay 122 has more than one antenna, then the method of FIG. 10 is repeated for each other relay antenna. After the method of FIG. 10 has been completed for each relay antenna, the LSAS BS 112 will have estimated all of the downlink channels ĥₘₖ₁ for downlink transmissions between the M LSAS antennas and the one or more relay antennas of relay 122 in DL FB1. At this point, after configuring all LSAS TX chains 200 of FIG. 2 for DL FB1, LSAS BS 112 will be able to use conjugate beamforming to generate and transmit downlink data signals to relay 122 in DL FB1.

Referring to FIGS. 9 and 10, those skilled in the art will know how to set up the transceiver to both transmit and receive on the same frequencies at the same time.

### Channel Calibration

Some if not all of the techniques described in this disclosure rely on the relative calibration of TX and RX chains 200 and 250 of FIGS. 2A and 2B for DL FB1 and/or UL FB2. Example relative calibration techniques are described in M. Guillaud, D. Slock, and R. Knopp, “A practical method for wireless channel reciprocity exploitation through relative calibration,” Signal Processing and Its Applications, 2005, Proceedings of the Eighth International Symposium, vol. 1, pp. 403-406, 28-31, 2005, and F. Kaltenberger, H. Jiang, M. Guillaud, and R. Knopp, “Relative channel reciprocity calibration in mimo/tdd systems,” Future Network and Mobile Summit, 2010, pp. 1-10, June 2010, the teachings of both of which are incorporated herein by reference.

The present disclosure has been described in the context of implementations in which the TX and RX chains have relatively flat responses across the bandwidth of the signals being processed. For implementations having responses that are not sufficiently flat, the bandwidth can be divided into frequency sub-ranges, where channel estimation is independently performed in each different frequency sub-range.

Although the disclosure has been described in the context of cellular systems that employ conjugate for downlink transmissions, the disclosure also includes cellular systems that employ other suitable techniques for downlink transmissions such as zero-forcing beamforming.

Although the disclosure has been described in the context of cellular systems having macrocells with LSAS base stations and small cells with either relays or repeaters, the disclosure also includes cellular systems having (i) macrocells with non-LSAS MIMO base stations instead of or in addition to macrocells with LSAS base stations and/or (ii) small cells with full-fledged small-cell base stations instead of or in addition to small cells with relays and/or small cells with repeaters. In general, the CSI estimation techniques described in this disclosure are applicable to any wireless channels between any two nodes that communicate using frequency division duplexing where at least one of the two nodes is a MIMO node.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. In a frequency-division duplexing (FDD) communication system having (i) a multiple in, multiple-out (MIMO) node with multiple MIMO-node antennas and (ii) a second node with at least one second-node antenna, wherein (1) the MIMO node transmits downlink (DL) data signals to the second node over multiple DL channels in a DL frequency band (FB) and (2) the second node transmits uplink (UL) data signals to the MIMO node over multiple UL channels in a UL FB different from the DL FB, a method comprising:
(a) the MIMO node receiving a first pilot signal from the second node in the UL FB;
(b) the MIMO node generating UL FB channel state information (CSI) based on the received first pilot signal;
(c) the MIMO node receiving a second pilot signal from the second node in the DL FB;
(d) the MIMO node generating DL FB CSI based on the received second pilot signal;
(e) the MIMO node decoding UL data signals from the second node based on the UL FB CSI; and
(f) the MIMO node generating DL data signals to the second node based on the DL FB CSI.

2. The method of claim 1, wherein:
the second node is a relay that initiates both the first and second pilot signals; and
the MIMO node generates the DL FB CSI based on the received second pilot signal and channel-calibration data for the multiple MIMO-node antennas.

3. The method of claim 2, wherein the channel-calibration data is relative channel-calibration data between transmit (TX) and receive (RX) chains for the multiple MIMO-node antennas.

4. The method of claim 1, wherein:
the second node is a repeater;
the first and second pilot signals are, respectively, re-transmitted received initial versions of the first and second pilot signals as received and re-transmitted by the repeater; and
the MIMO node generates the DL FB CSI based on the received second pilot signal and channel-calibration data for the multiple MIMO-node antennas.

5. The method of claim 4, wherein the channel-calibration data is relative channel-calibration data between TX and RX chains for the multiple MIMO-node antennas.

6. The method of claim 4, wherein:
step (a) comprises:
(a1) the MIMO node transmitting an initial version of the first pilot signal in the UL FB, wherein the repeater receives and re-transmits the initial version of the first pilot signal in the UL FB; and
(a2) the MIMO node receives the re-transmitted received initial version of the first pilot signal as the first pilot signal; and
step (c) comprises:
(c1) the MIMO node transmitting an initial version of the second pilot signal in the DL FB, wherein the repeater receives and re-transmits the initial version of the second pilot signal in the DL FB; and
(c2) the MIMO node receives the re-transmitted received initial version of the second pilot signal as the second pilot signal.

7. The method of claim 6, wherein:
step (a1) comprises the MIMO node transmitting the initial version of the first pilot signal in the UL FB from a single MIMO-node antenna; and
step (c1) comprises the MIMO node transmitting the initial version of the second pilot signal in the DL FB from a single MIMO-node antenna.

8. The MIMO node of claim 1.

9. The MIMO node of claim 8, wherein the MIMO node is a large-scale antenna system (LSAS) base station.

10. The MIMO node of claim 8, wherein:
at least one MIMO-node antenna has a configurable TX chain that can be selectively configured to transmit DL signals in either the DL FB or the UL FB; and
each MIMO-node antenna has a configurable RX chain that can be selectively configured to receive UL signals in either the DL FB or the UL FB.

11. In an FDD communication system having (i) a MIMO node with multiple MIMO-node antennas and (ii) a second node with at least one second-node antenna, wherein (1) the MIMO node transmits DL data signals to the second node over multiple DL channels in a DL FB and (2) the second node transmits UL data signals to the MIMO node over multiple UL channels in a UL FB different from the DL FB, a method comprising:
(a) the second node transmitting a first pilot signal in the UL FB; and
(b) the second node transmitting a second pilot signal in the DL FB.

12. The method of claim 11, wherein the second node is a relay that initiates both the first and second pilot signals.

13. The method of claim 11, wherein:
the second node is a repeater; and
the first and second pilot signals are, respectively, re-transmitted received initial versions of the first and second pilot signals as received and re-transmitted by the repeater.

14. The method of claim 13, wherein:
step (a) comprises:
(a1) the repeater receiving an initial version of the first pilot signal in the UL FB from a single LSAS-node antenna; and
(a2) the repeater re-transmitting the received initial version of the first pilot signal in the UL FB; and
step (b) comprises:
(b1) the repeater receiving an initial version of the second pilot signal in the DL FB from a single LSAS-node antenna; and
(a2) the repeater re-transmitting the received initial version of the second pilot signal in the DL FB.

15. The second node of claim 11.

16. The second node of claim 15, wherein the second node is a relay that initiates both the first and second pilot signals.

17. The relay of claim 16, wherein each relay antenna has a configurable TX chain that can be selectively configured to transmit UL signals in either the DL FB or the UL FB.

18. The second node of claim 15, wherein:
the second node is a repeater; and
the first and second pilot signals are, respectively, re-transmitted received initial versions of the first and second pilot signals as received and re-transmitted by the repeater.

19. The repeater of claim 18, wherein:
the repeater (i) receives an initial version of the first pilot signal in the UL FB from a single LSAS-node antenna and (ii) re-transmits the received initial version of the first pilot signal in the UL FB; and
the repeater (i) receives an initial version of the second pilot signal in the DL FB from a single LSAS-node antenna and (ii) re-transmits the received initial version of the second pilot signal in the DL FB.

20. The repeater of claim 18, wherein each repeater antenna has (i) a configurable TX chain that can be selectively configured to transmit UL signals in either the DL FB or the UL FB and (ii) a configurable RX chain that can be selectively configured to receive DL signals in either the DL FB or the UL FB.
